(19) United States
(12) Patent Application Publication
(10) Pub. No.: US 2011/0122614 A1
(43) Pub. Date: May 26, 2011

(54) Luminaire with Scattered Light Collection Device

(75) Inventor: Hsin-Ning KUAN, Wugu Township (TW)

(73) Assignee: Thermoking Technology International Co.

(21) Appl. No.: 12/626,641

(22) Filed: Nov. 26, 2009

(51) Int. Cl. F21V 5/00

(52) U.S. Cl. 362/235

(57) ABSTRACT

A luminaire is equipped with a scattered light collection device. The scattered light collection device includes a refractor and a light collection board set below a hollow cavity formed in the middle portion of the refractor. The portion of light rays emitted from the luminaire is gone astray and scattered here and there. The strayed light rays are caught by the colored light collection board and turned into effective light rays of the same color for illuminating the surroundings.

### BACKGROUND OF THE INVENTION

1. Field of the Invention

The present invention relates to a luminaire with scattered light collection device, and in particular, to a luminaire which has a colored light collection device to collect the scattered light and produce colored effective light.

2. Description of the Prior Art

There are many types of street lighting luminaires used to serve illumination of street or roadway. Most of them are only aimed at carrying out lighting function without considering how to improve the night scenery of the city to avoid monotonous and withering feelings.

For making the night scenery of the city more vigorous and attractive, the manufacturers of lighting equipment would recommend adding an extra colored light source on the same pole where the street lighting luminare is installed so as to provide colorful surrounding beautifying illumination other than the main street lighting luminaire which provides essentially functional lighting for dark street roads.

It should be understood that not all 100% of light produced by an optical system can be effectively used to illuminate the object, there may be some 5-10% of light beam going astray and scattering around here and there inefficiently. Such a phenomenon must be palliated for the sake of complying with the energy saving policy which is strongly demanded by the whole world.

In a bid to rectify the above depicted defects, the inventor of the present invention has gone to great lengths of intensive research based on many years of experience gained through professional engagement with this technical field, and finally come up with the innovative luminaire which can be used to take the portion of light emitted by the lamp which otherwise would be lost or poorly utilized, and redirect it into a more desirable distribution pattern, this optical system is named “Luminaire with Scattered Light Collection Device” in this invention which will be disclosed hereinafter.

### SUMMARY OF THE INVENTION

Accordingly, the object of the present invention is to provide a luminaire with scattered light collection device in which a colored transparent or semi-transparent refractor is provided for a luminaire so as to collect portion of light emitted by the light source which otherwise would go astray and be lost and turns it into a colored useful light for illumination.

It is another object of the present invention to provide a luminaire with scattered light collection device which is simply constructed, easily manipulatable and able to be manufactured with a low cost.

To achieve the above objects, the luminaire of the present invention comprises a fixture and a refractor. In the fixture there is contained a light surface and a plurality of LED dies. The light surface is provided with several engagement holes. The refractor which being bonded with the light surface of the fixture to serve as a scattered light collection device includes a frame with a hollow cavity opened in the middle portion thereof. Several mounting holes corresponding to the engagement holes provided on the light surface are formed around the fringe of the frame encircling the hollow cavity. A light collection board is provided below the frame. When the light source (LEDS) is actuated to emit lightrays, the light passes through the hollow cavity of the refractor and going to be diffused in all direction. Portion of the scattered light is then caught by the light collection board set below the frame of the refractor and turned into a colored effective illumination light.

The features and advantages of the present invention will be fully understood and appreciated from the following detailed description of the accompanying drawings.

### BRIEF DESCRIPTION OF THE DRAWINGS

FIG. 1 is an exploded, perspective view of the present invention.

FIG. 2 is a perspective view of the present invention.

FIG. 3 is schematic view showing the state of light radiation from the optical system of the present invention.

FIG. 4 is a schematic view showing the way of collecting scattered light in an embodiment of the present invention.

FIG. 5A and FIG. 5B are respectively an exploded, perspective view and a perspective view in another embodiment of the present invention.

FIG. 6 is an exploded, perspective view in one more embodiment of the present invention.

### DETAILED DESCRIPTION OF THE PREFERRED EMBODIMENT

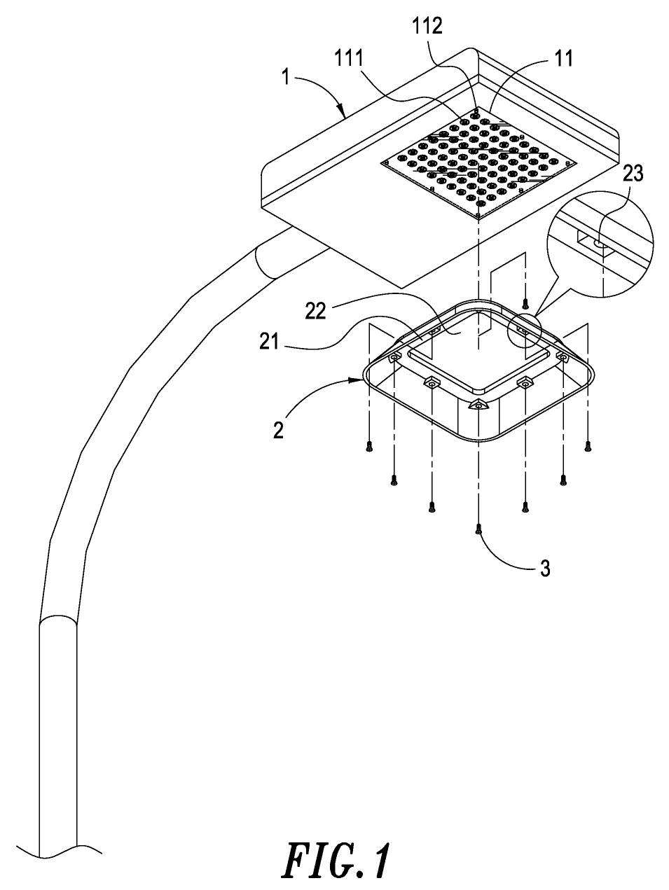

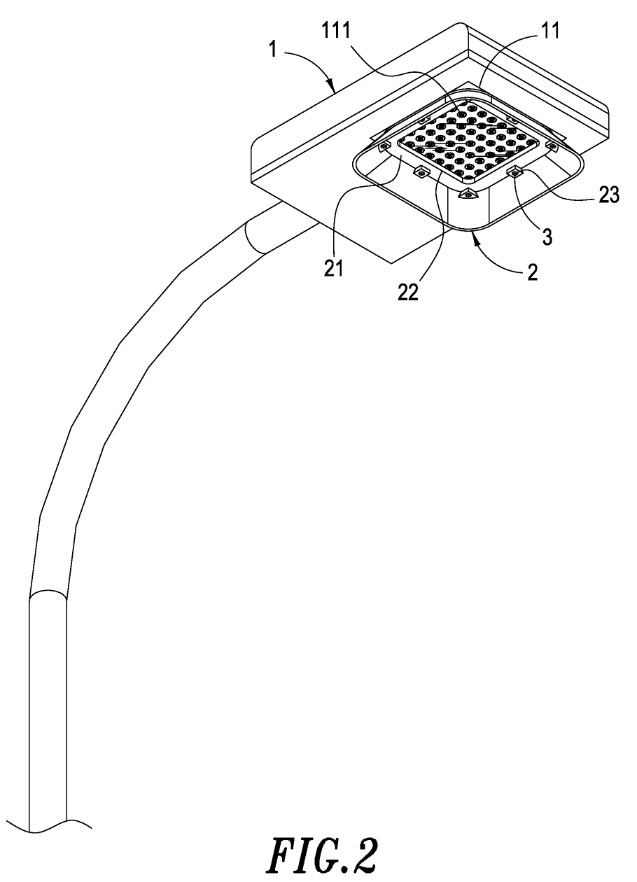

Referring to FIG. 1 and FIG. 2 in which an exploded, perspective view and a perspective view of the present invention are shown. The luminarie with scattered light collection device comprises the following components:

A fixture 1, the fixture 1 has a light surface 11 on which more than one LED 111 are disposed, and around the fringe of the light surface 11 there are provided with more than one engagement holes 112.

A refractor 2, this refractor 2 is made of a colored transparent or semi-transparent material and contains a frame 21. The middle portion of the frame 21 is formed into a hollow cavity 22 facing against the light surface 11, and several mounting holes 23 corresponding to the engagement holes 112 provided on the light surface 11 are formed around the fringe of the frame 21 in the manner encircling the hollow cavity 22. A light collecting board 24 is provided below the frame 21 in the manner downwardly extended from the fringe of the frame 21. The refractor 2 is bonded with the light surface 11 of the fixture 1.

The fixture 1 is engaged with the refractor 2 by inserting fixing members 3 into the mounting holes 23 of the refractor 2 and the engagement holes 112 of the fixture 1 so as to tighten up both fixture 1 and refractor 2 integrally together as one piece.

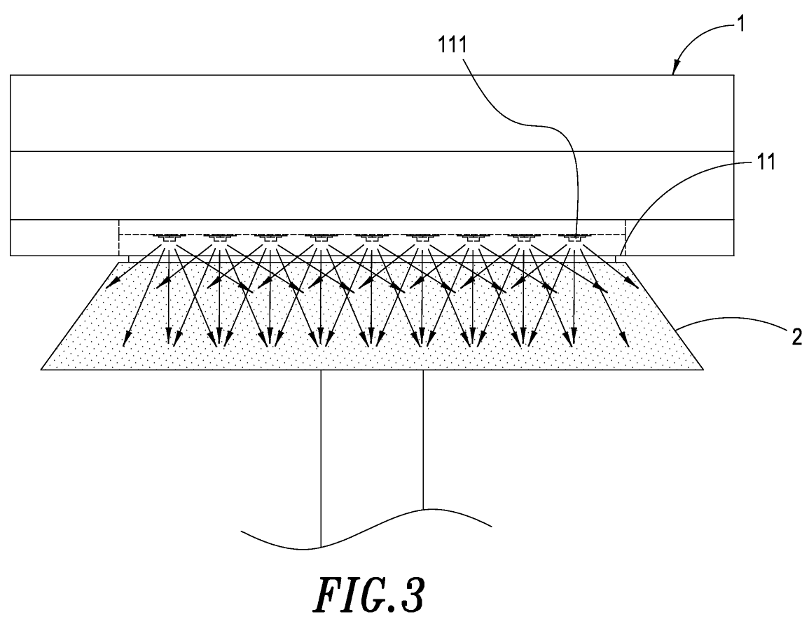

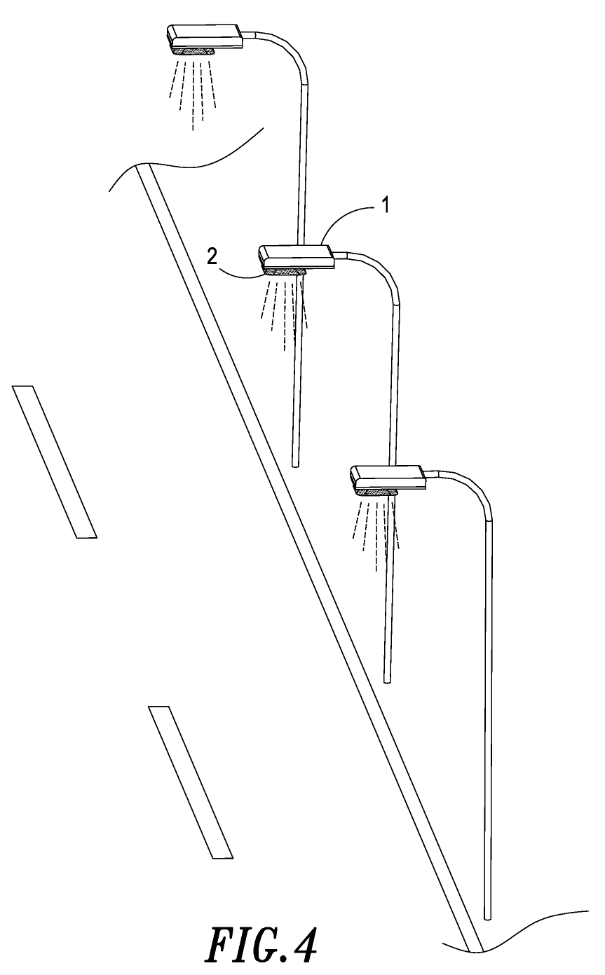

Referring to FIG. 3, this is a schematic view showing the state of light radiation from the optical system of the present invention, when the light source of the fixture 1 emits light rays downwardly, the gone astray and scattered light will be caught by a light collection board 24 of the refractor 2 so as to cause the light collection board 24 emit colored light that is the same color of the material which makes up the refractor 2. As shown in FIG. 4, when such an optical system is applied to the street lighting, it is definite that the night scenery of the street will be more romantic beautiful and vivid.

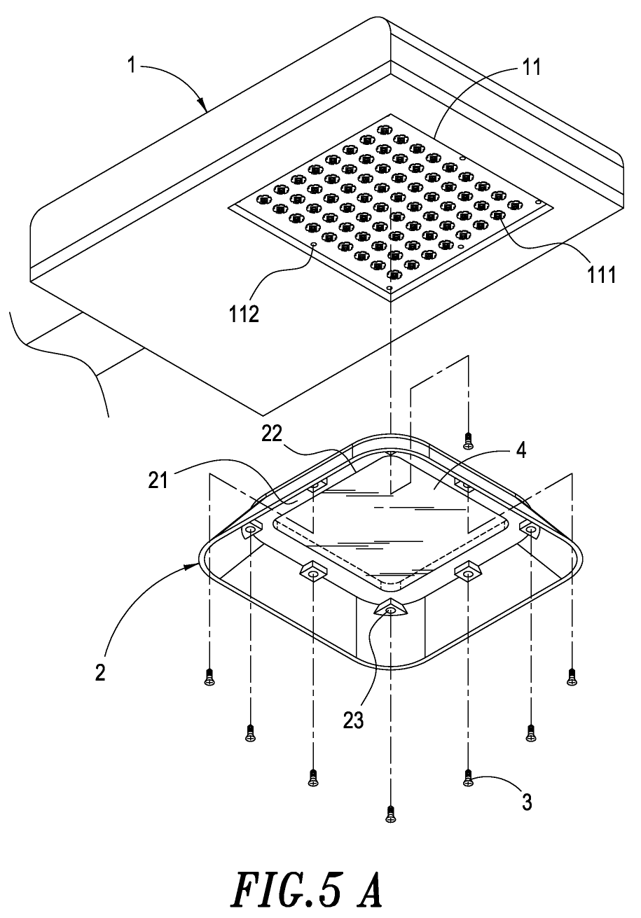

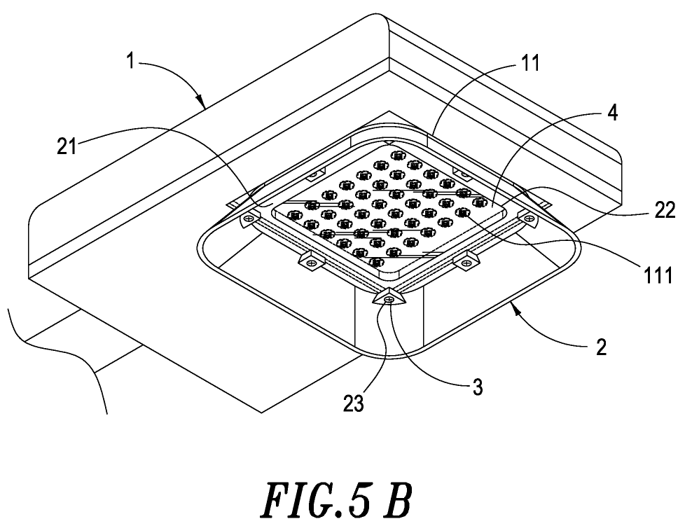

Referring to FIG. 5A and FIG. 5B, the two FIGS. 5A and 5B respectively show an exploded, perspective view and a perspective view in another embodiment of the present invention. It is observed that a board 4 made of transparent material is bonded to the frame 21 at the hollow cavity 21 so as to serve as a shade of the light surface 11 and seal the light surface 11 thereby protecting the fixture 1 from infringement of dust.

Meanwhile, the fringe 21 of the refractor 2 may be directly formed into a transparent or semi-transparent protective glove.

Meanwhile, as shown in FIG. 2, the light collection board 24 of the refractor 2 may be inclined.

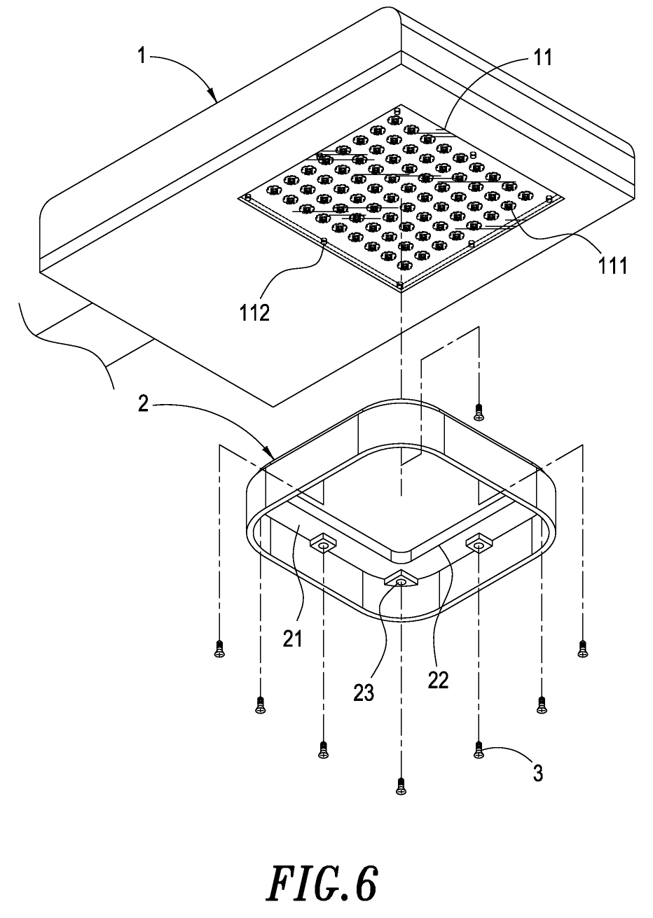

Meanwhile, as shown in FIG. 6, the light collection board 24 of the refractor 2 may be uprightly erected.

It emerges from the description of the above embodiments that the invention has several noteworthy advantages compared with those according to the prior art, in particular:

1. In the present invention gone astray and scattered light of the optical system are caught by the colored transparent or semi-transparent refractor to be turned into effective light rays with the same color of the refractor.

2. The optical system of the present invention can be simply constructed, easily manipulated and able to be manufactured with low cost.

3. No extra power supply is needed to operate this optical system so that it is energy saving.

Many changes and modifications in the above described embodiments of the invention can, of course, be carried out without departing from the scope thereof. Accordingly, to promote the progress in science and the useful arts, the invention is disclosed and is in tended to be limited only by the scope of the appended claims.

What is claimed is:

1. A luminaire with scattered light collection device comprising:
a fixture having a light surface on which a plurality of light emitting diodes (LEDs) are disposed; and
a colored refractor with a hollow cavity formed in a middle portion encircled by a frame thereof, said hollow cavity being faced against said light surface, and a light collection board being downwardly extended from a fringe of said frame; wherein the frame of said refractor and the light surface of said fixture are engaged with each other.

2. The luminaire of claim 1, wherein a transparent or a semi-transparent board is provided in said hollow cavity so as to seal the light surface of said fixture for dust proof

3. The luminaire of claim 1, wherein said light collection board of said refractor is inclined.

4. The luminaire of claim 1, wherein said light collection board of said refractor is uprightly erected.

5. The luminaire of claim 1, wherein around the fringe of said light surface are provided with more than one engagement holes, and several mounting holes corresponding in position to said engagement holes are formed around the fringe of said frame in the manner encircling said hollow cavity so that said refractor and said fixture are engaged with each other by coupling said engagement holes with said mounting holes together with fixing members.
